(19) United States
(12) Patent Application Publication
(10) Pub. No.: US 2010/0116947 A1
(43) Pub. Date: May 13, 2010

(54) CLIP FOR ATTACHING PIPES

(76) Inventor: Wolfram Winkler, Ueberlingen (DE)

Correspondence Address: K.F. ROSS P.C., 5683 RIVERDALE AVENUE, SUITE 203 BOX 900, BRONX, NY, 10471-0900, US

(21) Appl. No.: 12/529,375

(22) PCT Filed: Mar. 5, 2008
(86) PCT No.: PCT/EP2008/001725

§ 371 Date: Nov. 11, 2009

(30) Foreign Application Priority Data
Mar. 6, 2007 (DE) 10 2007 011 194.2

(51) Int. Cl. F16L 3/12; F16L 3/08

(52) U.S. Cl. 248/73; 248/74.1

(57) ABSTRACT

The invention relates to a clip (1) for attaching pipes (2) to a linear beam element (3), wherein at least one mounting (5) for a pipe (2) is provided. At least two fastening jaws (7) with which the clip can be fixed to the linear beam (3)are provided. When the clip is not in the fixed state, an introduction gap (8) is present between the fastening jaws (7) through which the linear beam element (3) can be introduced into a linear mounting channel (9). During the conversion of the clip (1) into the fixed state, the fastening jaws (7) can be introduced into a fastening opening (12) with at least partial closure of the introduction gap (8). When the clip (1) is in the fixed state, the linear beam element (3) is taken up in the linear mounting channel (9) between the fastening jaws (7) in such a way that said linear beam element (3) cannot be lost.

The invention concerns a clip for securing pipes to an elongated support element, at least one pipe seat being provided. The pipes that are to be fixed are especially heating pipes, primarily for floor heating. The elongated support element is particularly a metal bar and preferably a wire of a steel reinforcement mesh or of a welded mesh. In place of the term mounting clip, in the following, the short form, clip, will also be used.

Mounting clips of the type mentioned above are known in practice in various embodiments. But many of these known clips distinguish themselves by the disadvantage that an exact and position-precise alignment of the clip is only possible with difficulty or expensive. A majority of the clips also has the disadvantage that a tight and functionally safe fixation at the steel bar cannot always be ensured or not under all conditions. Further, the use of many clips is also limited in that they can only be used effectively at certain positions in a steel reinforcement mesh and that their possibilities of use depend in particular on the specific dimensions of the steel reinforcement mesh. To that extent, many of the known clips are in need of improvement.

The object of the invention is to provide a mounting clip of the type mentioned above with which the disadvantages mentioned above can be avoided.

To attain this object, the invention proposes a mounting clip for fixing pipes to an elongated support element where at least one pipe seat, wherein

at least two holding jaws are provided with which the clip is fixable to the elongated support element,

in an unmounted position of the clip the holding jaws form a mouth through which the elongated support element can be fitted into a linear bar seat,

the holding jaws, during movement of the clip into the mounted position can be fitted or pressed into a retaining seat on the lower side of the mounting clip with at least partial closure of the mouth, and

the elongated support element is captured in the linear bar seat between the holding jaws in the mounted position of the clip.

The fact that the elongated support element can be fitted into the bar seat means, within the scope of the invention, that the clip is fitted to the elongated support element such that the elongated support element is held in the linear bar seat of the clip. The mounting clip in accordance with the invention is provided in particular for fixation to a steel reinforcement mesh and specifically at a straight steel bar or wire of a steel reinforcement mesh. To this end, in the following, the term bar is also used in place of elongated support element. To the extent the term bar is used there, it also means the more general term, elongated support element. It is within the scope of the invention that the clip is made of plastic. Plastic material has especially proven itself in mounting clips in accordance with the invention. Further, it is within the scope of the invention that mounting clips in accordance with the invention can be fixed with a setting tool. Such a setting tool advantageously has a magazine that holds a number of the mounting clips. With each actuation, particularly by manual actuation of the setting tool, one mounting clip is fixed to the elongated support element. The fact that the elongated support element is captured in the bar seat, means, within the scope of the invention, that the elongated support element or the bar can no longer, or not without impairing or damaging/destroying the clip, come out of the bar seat.

It is recommended that the pipe seat be part-cylindrical and that the pipe is mounted with positive fit in the pipe seat. Advantageously, the pipe can be attached by a detent and/or can be fixed by means of a clamp in the pipe seat. Thus, at least one latch element is provided and/or provided at the part-cylindrical pipe seat of the clip. For the making a clamp. a part-cylindrical pipe seat is advantageously made somewhat smaller in cross section than the cross section of the pipe that is to be held.

It is within the framework of the invention that the bar seat for the elongated support element extends transverse to a pipe that is mounted in the pipe seat. In the mounted position of the clip, the pipe is thus oriented perpendicular to the elongated support element/bar to which the clip is fixed. This way, a perpendicular laying of pipes/heating pipes is possible, so to speak, relative to the horizontal bars of a steel reinforcement mesh.

According to a very preferred embodiment of the invention, in the unmounted of the clip the holding jaws are attached to the clip at the lower end of the retaining seat by at least one frangible web, and this frangible web breaks on movement of the clip into the mounted position as intended. Here, the lower end of the retaining seat means the bottom face or end of the retaining seat that is facing the elongated support element. Such a frangible web is in particular a thin plastic element, preferably a thin plastic film that breaks on the exertion of pressure on mounting the clip. According to a particularly preferred embodiment, the holding jaws are connected at their respective upper outer edges to a base and the base is connected by at least one frangible web, preferably by two predetermined frangible webs that are opposite to each other, to the clip at the lower end of the retaining seat. It is recommended that the horizontal cross section surface of the base corresponds to approximately the retaining seat or is somewhat smaller than the horizontal cross section surface of the retaining seat. During movement of the clip into the mounted position, the base with the holding jaws is then fitted into the retaining seat.

Otherwise, it is within the scope of the invention that the bar seat for the elongated support element is located between the upper inner faces of the holding jaws. It is further within the scope of the invention that the longitudinal axis of the bar seat be oriented parallel to the longitudinal direction of the mouth between the holding jaws. According to an especially preferred embodiment of the invention, the mouth tapers toward the bar seat for the elongated support element in the unmounted position of the clip. In other words, the inner jaw faces of the holding jaws converge toward the bar seat. In this manner, a simple and problem-free introduction of the base into the bar seat is possible in accordance with the invention or a simple and precise attachment of the clip to a precise position of the bar seat on the bar. Advantageously, the bar seat is formed with a bar seat for a positive fit of the bar. It is recommended that the bar seat be shaped to have a round horizontal cross section, preferably circular.

It is understood that the inner jaw faces that converge toward the bar seat diverge. According to a recommended embodiment of the invention, the inner jaw faces that define the mouth of the holding jaws are shifted on movement of the clip into the mounted position from their diverging (converging) orientation into a parallel orientation. In other words, the inner jaw faces of the holding jaws are located parallel or essentially parallel to each other in the mounted position of the clip. It is recommended that the holding jaws are attached with their outer side edges by respective small or thin hinge webs to the base so that during movement into the mounted position, a corresponding deflection of the holding jaws from the diverging orientation into the parallel orientation is possible. Advantageously, the inner jaw faces of the holding jaws abut each other in the mounted position of the clip, so that this way, the mouth is completely closed.

It is within the scope of the invention that the holding jaws are mounted in a positive fit in the mounted position of the clip and are essentially received completely in the retaining seat. Advantageously, the outer jaw faces of the holding jaws have a positive fit at the sides of the retaining seat in the mounted position of the clip. Preferably, the lower front side surfaces of the holding jaws are aligned with the lower front side surfaces of the sides of the retaining seat in the mounted position of the clip.

An especially preferred embodiment of the invention is characterized in that the outer jaw faces of the holding jaws are provided with respective positive latch formations that form positive locking connections at the sides of the retaining seat with complementary positive latch formations in the mounted position of the clip. It is recommended that the positive latch formations or the complementary positive latch formations form a nondetachable positive locking connection between the holding jaws and the sides of the retaining seat. Here, nondetachable connection means that a connection cannot be released without damaging or destroying the clip. According to an especially preferred embodiment of the invention, the positive latch formations and/or the complementary positive latch formations are shaped as sawteeth extending along the outer jaw faces and/or along the sides. With the help of these sawteeth, a very effective fixation can be achieved in the retaining seat and, particularly, a very effective nondetachable positive locking connection.

According to the recommended embodiment of the invention, the clip is made of a plastic, a polyamide or polyolefin. When a polyolefin is selected as clip material, polypropylene is recommended as the material.

According to a special embodiment of the invention, the clip has two bodies between which the pipe seat is located, and each of these two bodies is equipped with two holding jaws, a mouth, a bar seat, and a retaining seat. This clip is thus fastened to the bar at two separate positions that are separated by the pipe seat. This way, a particularly effective and tight connection is possible.

First, the invention is based on the knowledge that a mounting clip in accordance with the invention can be oriented or fixed in an easy and problem-free way at a precise position on an elongated support element. To accomplish this, especially the diverging mouth between the holding jaws also contributes. In particular, the mounting clip in accordance with the invention can be fixed with a fixing tool in a simple way precisely at the desired installation site. Further, the invention is based on the knowledge, that a mounting clip in accordance with the invention can be fixed tightly and functionally safe on an elongated support element. The connection that is made in this manner easily is withstands conventional mechanical loads. It is also of special significance within the scope of the invention that a nondetachable connection can be established between the elongated support element and the clip. This connection would only be able to be unfastened again subject to a high expenditure of energy and by destroying the clip. Furthermore, the clip in accordance with the invention distinguishes itself in that it, with respect to its fixing position at a steel reinforcement mesh, is almost unlimited and especially in fixing or laying pipes it is largely independent of the grid of the steel reinforcement mesh. It is also to be emphasized that a clip in accordance with the invention can be manufactured easily and without any problems, as well as cost effectively.

In the following, the invention is explained in more detail using a drawing that shows only one embodiment. Therein:

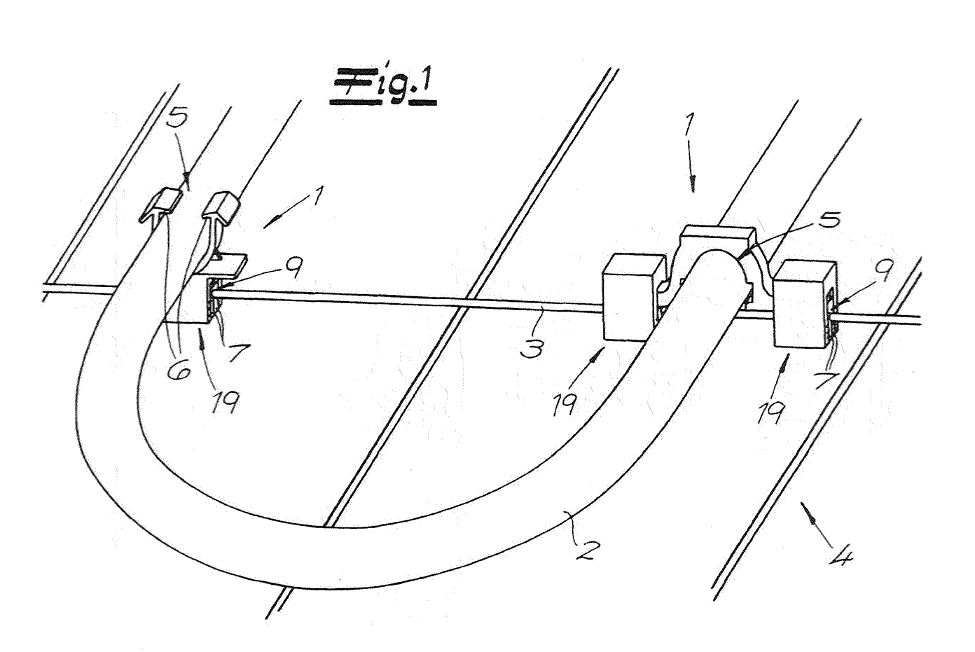

FIG. 1 is a perspective schematic illustration of a portion of a steel reinforcement mesh with two mounting clips according to the invention attached to it;

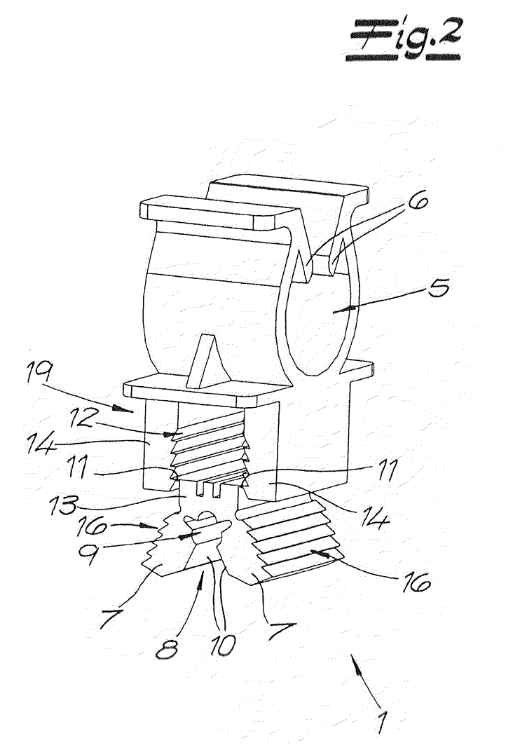

FIG. 2 is a perspective view of a first embodiment of the mounting clip in accordance with the invention;

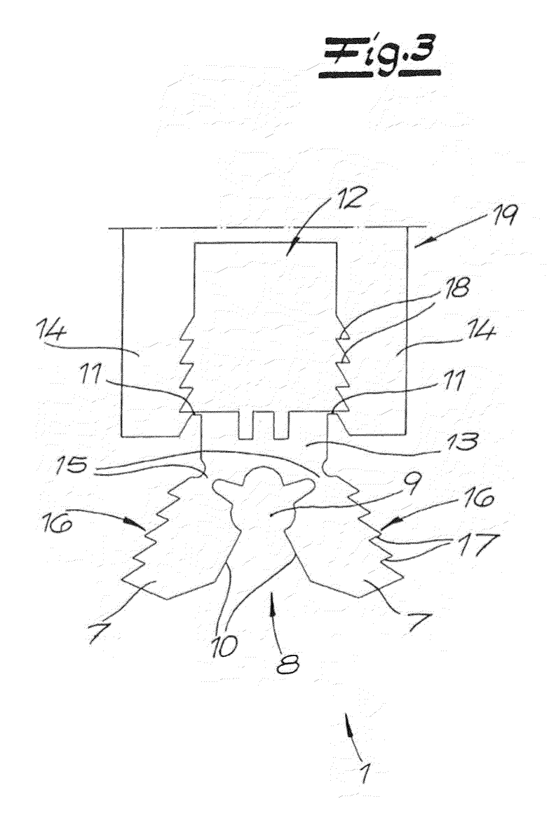

FIG. 3 is an end view of the clip of FIG. 2 in the unmounted condition;

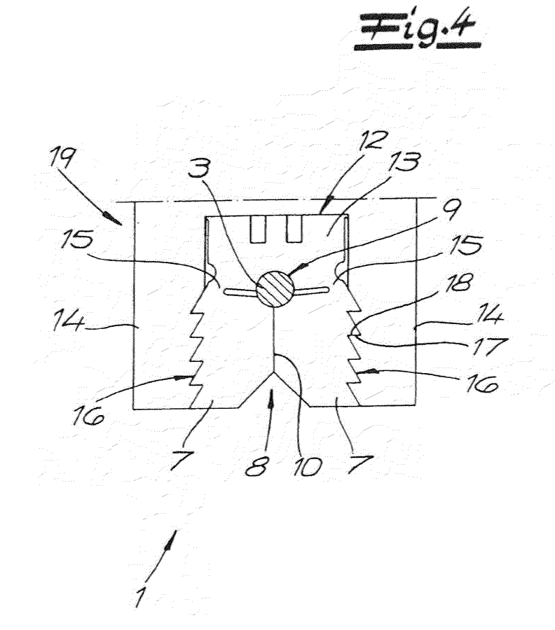

FIG. 4 is the clip of FIG. 3 in mounted condition; and

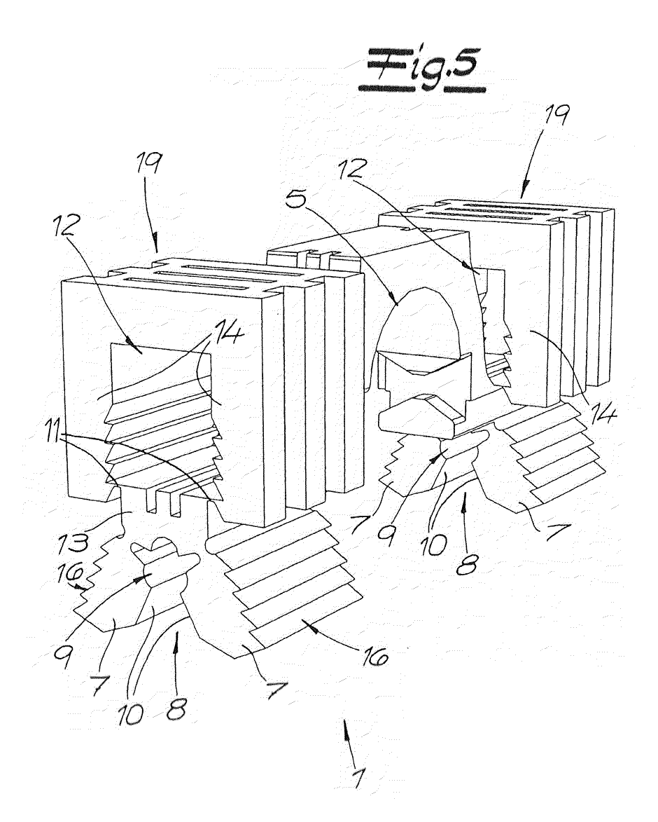

FIG. 5 is a perspective view of a second embodiment of a mounting clip according to the invention.

The figures show a mounting clip 1 in accordance with the invention for securing pipes 2 to an elongated support element. In the embodiment according to the figures, the elongated support element is a steel bar or a wire 3 of a steel reinforcement mesh 4. The mounting clip 1 in accordance with the invention has a pipe seat 5 for the pipe 2 shaped as a part-cylinder in the two embodiments according to the invention shown in the figures. The pipe 2 is a positive fit in this pipe seat 5. In the embodiment according to FIG. 2, detents 6 are shown so that the pipe 2 can be snapped into the pipe seat 5, securing the pipe 2 in the pipe seat 5.

In the embodiment shown in FIGS. 2 to 4, two holding jaws 7 are provided on the mounting clip 1 for securing the clip 1 to the bar 3. In the unmounted position of the clip 1 shown in FIGS. 2 and 3, a mouth 8 is formed between the holding jaws 7, through which the bar 3 can be fitted into a linear bar seat 9. In this unmounted position of the clip 1, the mouth 8 tapers toward the bar seat 9. In other words, inner jaw faces 10 of holding jaws 7 diverge downward so that the bar 3 can be mounted problem-free through a relatively wide opening of the mouth 8 into the linear bar seat 9.

When the clip 1 has gone from the unmounted position (FIGS. 2, 3) into the mounted position (FIG. 4), the holding jaws 7 are fitted into a retaining seat 12 that holds the mouth 8 closed. In the unmounted position of the clip 1, the holding jaws 7 are connected to the clip 1 at two frangible webs 11 at the lower end of the retaining seat 12. To move the clip into the mounted position, the clip 1 is pushed in to rupture the frangible webs 11, so that then the holding jaws 7 can enter unimpeded into the retaining seat. In the embodiment according to the figures, the holding jaws 7 are carried on a base 13 at their upper outer edges and this base 13 is connected by the two predetermined frangible webs 11 in the lower end of the retaining seat 12 to the sides 14 defining the retaining seat 12. The frangible webs 11 in the embodiment are preferably made as a thin plastic film that breaks or tears when a load is applied. Otherwise, the holding jaws 7 are connected by hinge webs 15 to the base 13, these hinge webs 15 being significantly thinner than the holding jaws 7 so that elastic deflection of the holding jaws 7 during movement into the mounted position and during the corresponding pushing together of the holding jaws 7 is possible without any problem. Moreover, in the embodiment, the base 13 has a horizontal cross sectional area that is slightly smaller than the horizontal cross sectional area of the retaining seat 12, so that the base 13 can be fitted into the retaining seat 12 with the holding jaws 7 when being mounted.

The figures show that the bar seat 9 is provided between the upper inner faces of the holding jaws 7. Preferably, and in the embodiment, the linear bar seat 9 is of circular cross section. Further, the figures show that the bar seat 9 extends perpendicular to the pipe 2 mounted in the pipe seat 5. During installation, the pipe 2 is thus aligned transverse to the bar seat 9 and thus also perpendicular to the bar 3. This makes it possible, so to speak, to have a lay the pipes 2 crosswise on the bars 3 of the steel reinforcement mesh 4.

When the clip 1 goes from the unmounted position (FIGS. 2, 3) into the mounted position (FIG. 4), inner faces 10 of the holding jaws 7 that define the mouth 8 are converted from their is diverging orientation into a parallel orientation. As has already been described above, the relatively thin hinge webs 15 make a corresponding deflection of the holding jaws 7 possible. FIG. 4 shows that in the mounted position according to a preferred embodiment, the inner jaw faces 10 of the holding jaws 7 flatly abut each other and the mouth 8 is thereby completely closed. The bar 3 is then captured in the linear bar seat 9 between the holding jaws 7.

In the mounted position of the clip 1, the base 13 and the holding jaws 7 are mounted with a positive fit in the retaining seat 12. Preferably as in the embodiment, outer jaw faces 16 of the holding jaws 7 each have positive latch formations 17 that are shaped as sawteeth. The sides 14 of the retaining seat 12 have correspondingly shaped complementary positive latch formations 18 that are also shaped as sawteeth. In the mounted position of the clip, these positive latch formations 17 and the complementary positive latch formations 18 form a nondetachable positive locking connection between the holding jaws 7 and sides 14 of the retaining seat 12. The positive latch formations shaped as sawteeth advantageously extend over the entire length of the holding jaws 7. Accordingly, the complementary positive latch formations 18 extend over the entire length of the sides 14 of the retaining seat 12. Preferably and in the embodiment, the retaining seat 12 is defined only by two opposite sides 14. On the two other sides the retaining seat 12 is open, i.e. not closed by sides.

FIG. 5 shows a special embodiment of the mounting clip 1 according to the invention. In this embodiment, two bodies 19 are provided between which the pipe seat 5 for pipe 2 is provided. The two bodies 19 are, just like the single body 19 of the clip according to FIGS. 2 to 4, basically parallopipedal. Each of the two bodies 19 of the clip 1 according to FIG. 5 is shaped just like the body 19 of the clip according to FIGS. 2 to 4. This means that each of the two bodies 19 is equipped with the two holding jaws 7, a mouth 8, a bar seat 9, and a retaining seat 12. Otherwise, the design of the body 19 is identical with respect to the characteristics that are essential for the invention.

1. A mounting clip for securing a pipe to an elongated support element, at least one pipe seat being provided for the pipe, wherein
at least two holding jaws are provided with which the clip can be fixed to an elongated support element,
in an unmounted position of the clip, the holding jaws form a mouth through which the elongated support element can be fitted into a linear bar seat,
the clip is provided with a retaining seat,
the holding jaws can be fitted into a retaining seat during movement of the clip into a mounted position with at least partial closure of the mouth, and
in the mounted position of the clip, the elongated support element is captured in the linear bar seat between the holding jaws.

2. The mounting clip according to claim 1 wherein the pipe seat for the pipe is part-cylindrical and the pipe can be mounted with positive fit in the pipe seat.

3. The mounting clip according to claim 1 wherein the pipe can be fixed by a detent or a clamp in the pipe seat.

4. The mounting clip according to claim 1 wherein the bar seat extends transverse to a pipe in pipe seat.

5. The mounting clip according to claim 1 wherein the holding jaws in the unmounted position of the clip are connected to the clip by at least one frangible web at a lower end of the retaining seat, and the frangible web breaks during movement of the clip into the mounted position.

6. The mounting clip according to claim 1 wherein the mouth tapers toward the bar seat in the unmounted position of the clip.

7. The mounting clip according to claim 6 wherein inner jaw faces of the holding jaws that define the mouth are shifted during movement of the clip into the mounted position from a diverging orientation into a parallel orientation.

8. The mounting clip according to claim 7 wherein the inner jaw faces abut each other in the mounted position of the clip and thereby completely close the mouth.

9. The mounting clip according to claim 1 wherein the holding jaws are mounted with positive fit in the retaining seat in the mounted position of the clip.

10. The mounting clip according to claim 9 wherein outer faces of the holding jaws have respective positive latch formations that form positive locking connections in the mounted position of the clip with complementary positive latch formations on sides of the retaining seat.

11. The mounting clip according to claim 10 wherein the positive latch formations or the complementary positive latch formations form a nondetachable positive locking connection between the holding jaws and the sides of the retaining seat.

12. The mounting clip according to claim 10 wherein the positive latch formations or the complementary positive latch formations are shaped as sawteeth extending along the outer jaw faces or along the sides.

13. The mounting clip according to claim 12 wherein the clip is made of plastic, a polyamide or a polyolefin.

14. The mounting clip according to claim 1 wherein the clip is provided with two bodies between which pipe seat for the pipe is located, and each body is provided with two holding jaws, a mouth, a bar seat and a retaining seat.

15. A mounting clip for securing a pipe to an elongated support bar, the clip comprising:
a base;
two holding jaws pivotal on the base between an outer open position in which bar can be introduced between the jaws and engaged with the base and an inner closed position forming with the base a bar seat at least generally complementary to the bar and in which the bar is captured;
a body having a pair of sides forming a retaining seat in which in a mounted position the base and jaws are at least partially receivable only in the closed position of the jaws, the jaws being pivoted on the base such that on movement of the base and body together into the mounted position shifts the jaws from the open position to the closed position;
a pipe seat fixed on the body and engageable around the pipe; and
formations between the body and the base locking the body and base together in the mounted position.

16. The pipe-mounting clip defined in claim 15 wherein the pipe seat extends along an axis generally perpendicular to an axis of the bar seat.

17. The pipe-mounting clip defined in claim 15, further comprising
at least one frangible web unitarily formed with the base and with the body and normally holding the base in an unmounted position aligned with and outside the retaining seat, whereby the base can only be pushed into the retaining seat by rupturing the webs.

18. The pipe-mounting clip defined in claim 17, wherein the formations are oppositely directed sawteeth formed on confronting faces of the base and body and oriented so as to permit movement of the base from the unmounted to the mounted position but to prevent opposite movement from the mounted to the unmounted position.

19. The pipe-mounting clip defined in claim 18 wherein the base, body, pipe seat, frangible webs, and arms are unitarily formed of plastic.

20. The pipe-mounting clip defined in claim 15 wherein the pipe seat is a form of part-cylindrical and elastically deformable arms unitary with the body.
